(19) United States
(12) Patent Application Publication
(10) Pub. No.: US 2012/0071324 A1
(43) Pub. Date: Mar. 22, 2012

(54) Biocidal substances

(75) Inventors: Hermann Uhr, Leverkusen (DE); Daniel Schlawe, Leverkusen (DE); Tanja Gerharz, Dusseldorf (DE); Frank Sauer, Langenfeld (DE); Thomas König, Leverkusen (DE); Benno Ulfik, Leverkusen (DE)

(73) Assignee: LANXESS DEUTSCHLAND GMBH, Leverksuen (DE)

(21) Appl. No.: 13/088,718

(22) Filed: Apr. 18, 2011

(30) Foreign Application Priority Data
Apr. 22, 2010 (EP) 10160710.9

(51) Int. Cl. A01N 37/34; C08L 25/12; A01P 13/00

(52) U.S. Cl. 504/158; 523/122

(57) ABSTRACT

The present invention relates to biocidal and more particularly algicidal substances comprising one or more polymers which in turn comprise one or more biocides such as more particularly algicides, where at least one polymer has structural elements which derive from acrylonitrile. The invention further relates to biocidal compositions comprising aforesaid biocidal substances in particulate form, to a process for preparing the biocidal substances and the biocidal compositions and to the use of the biocidal compositions for protecting technical materials.

The present invention relates to biocidal and more particularly algicidal substances comprising one or more polymers which in turn comprise one or more biocides such as more particularly algicides, where at least one polymer has structural elements which derive from acrylonitrile. The invention further relates to biocidal compositions comprising aforesaid biocidal substances in particulate form, to a process for preparing the biocidal substances and the biocidal compositions and to the use of the biocidal compositions for protecting technical materials.

Biocides, such as more particularly fungicides and algicides are used in technical materials such as paints and renders, for example, in order to protect these materials from infestation by fungi and/or algae. Infestation with fungi and/or algae, oftentimes results in unwanted visual changes and also in the destruction of the material to be protected.

The biocides are employed typically in the form of formulations, such as solutions and dispersions, for example, which are incorporated into the technical materials.

In many cases, however, the long-term activity in the technical materials to be protected, such as more particularly paints and renders, is not good enough, since the biocides, particularly in outdoor use, are leached from the materials by water from precipitation or condensation, for example. This leaching results in a drop in concentration of the biocides, leading over time to a reduction in the biocidal activity or even to an absence of activity. In addition to the shortened activity period, the precipitation of condensation water with its freight of biocides can enter the environment, more particularly the groundwater, resulting in unwanted contamination.

For this reason, the general objective is to retard leaching to such an extent that the amount of biocides released is so small that there is no unnecessary environmental pollution, but the amount is at the same time sufficient to suppress the growth of unwanted microorganisms.

From the prior art there is a multiplicity of methods known for achieving the leaching characteristics and the release of biocides by encapsulation, adsorption to solid carriers or inclusion in a polymer matrix.

Thus, for example, WO 2004/000953 A discloses the introduction of biocides into microcapsules having wall materials made of specific formaldehyde-melamine resins, in order to allow them to be used in coating materials which have a pH-Wert of more than 11.

EP 0 758 633 A describes porous granules which comprise chemical substances, including, for example, biocides, for instance, and which release these compounds slowly in the application.

Moreover, WO 2009/00650 A describes biocide-containing, thermoplastic polymer particles of defined size in which the biocide is distributed uniformly in the polymer. The polymer particles are obtained by extrusion and milling.

JP-A 2004-099557 describes fine particles of biocide-containing resins which are used more particularly in aqueous emulsion paint for suppressing the growth of microorganisms.

The biocide-containing capsules or carrier-bound biocides, or biocides dissolved in a carrier material, that are known from the prior art, have, however, a number of properties which make them of only limited suitability for application in technical materials, more particularly paints and renders. For instance, the low shear strength of biocide-containing capsules typically does not allow them to be incorporated, for example, into liquid or solid materials under standard, technical conditions. Furthermore, the rate of release of biocide is difficult to control.

In respect of the biocides, and more particularly algicides, whose solubility in water is typically too good, the known polymer particles exhibit not inconsiderable leaching.

It was therefore an object of the present invention to provide biocidal substances which eliminate the disadvantages of the prior art.

Biocidal substances have now been found comprising one or more polymers comprising one or more biocides, at least one polymer having structural elements which derive from acrylonitrile.

The term “comprising” with respect to the polymers comprising one or more biocides encompasses not only partial or, preferably, complete inclusion of amorphous or crystalline biocides into the polymer or polymers of the biocidal substances, but also monolithic incorporation of one or more biocides into the polymer or polymers of the biocidal substances, the incorporation being homogeneous or inhomogeneous.

The term “monolithic” in this context means that the appearance is uniform, i.e., in contrast to the aforesaid polymers in which amorphous or crystalline biocides are included, a phase boundary between biocides and polymer is not apparent in the wavelength range of visible light—and preferably does not exist. In this context, the terms frequently used in the literature include “solidified solutions”, “solidified melts” or “polymer matrix”.

The context of the invention encompasses the radical definitions and parameters given above and below, given generally or in ranges of preference, both alone and in any desired combination with one another.

In the context of the invention, a polymer having structural elements which derive from acrylonitrile is any polymer which comprises the structural element of the formula (I):

—CH₂—(CHCN)— (I).

Polymers of this kind are typically prepared by polymerization of monomer mixtures which comprise acrylonitrile.

In one particularly preferred embodiment, the polymer comprises styrene acrylonitrile copolymers, referred to as styrene-acrylonitrile (SAN).

In such SAN, the ratio of styrene to acrylonitrile in the monomer mixture to be polymerized may be varied within a wide range in accordance with the desired profile of properties. Preference is given to using those SAN which comprise 50% to 90% by weight of structural elements which derive from styrene and which further comprise 10% to 50% by weight of structural elements which derive from acrylonitrile, the sum of the two aforesaid structural elements, based on the polymer as such, being preferably 100% by weight.

Particular preference is given to using those SAN which comprise 70% to 85% by weight of structural elements which derive from styrene and which further comprise 15% to 30% by weight of structural elements which derive from acrylonitrile, the sum of the two aforesaid structural elements, based on the polymer as such, being preferably 100% by weight.

Suitable SAN grades are available commercially, in the form of, for example Lustran® from Ineos, Luran® from BASF, Tyril® from Dow Chemicals, Kostil® from Polimeri, Cevian® from Daicel and Sanrex® from Techno Polymer Co.

It is likewise preferred for the polymer having structural elements which derive from acrylonitrile to have per se a glass transition temperature of 50° C. to 220° C., preferably from 80 to 150° C., more preferably 85 to 130° C.

In another embodiment, the polymer having structural elements which derive from acrylonitrile possesses a molar mass of more than 1000 g/mol, preferably from 2000 to 200 000 and particularly preferably from 3000 to 170 000.

The biocidal substances comprise one or more polymers, and at least one polymer, as for example one polymer or a blend of two or more polymers comprising, or each comprising, one or more biocides, has structural elements which derive from acrylonitrile.

In one embodiment, the biocidal substances, besides at least one polymer comprising structural elements which derive from acrylonitrile, additionally comprise one or more polymers which have no structural elements which derive from acrylonitrile. Such further polymers are preferably thermoplastic polymers, such as, for example polyacrylates; polyalkylene glycols, such as more particularly polyethylene glycols or polyethylene-polypropylene glycol copolymers (block copolymers or randomly distributed); polyurethanes; polyamides; polyureas; polycarbonates; polyesters or mixtures of the aforementioned polymers.

In this case, the biocidal substance comprises a blend of at least two polymers comprising one or more biocides.

The fraction of these further polymers in the biocidal substance can be varied within a broad range, the fraction being preferably up to 20% by weight, more preferably 0.0001 to 20% by weight, very preferably 0.0001 to 5% by weight, based on the sum total of polymers.

In one preferred embodiment the biocidal substance comprises to an extent of at least 98% by weight preferably exclusively, those polymers which have structural elements which derive from acrylonitrile, based on the sum total of polymers.

In one particularly preferred embodiment the biocidal substance comprises to an extent of at least 98% by weight preferably exclusively, a polymer which has structural elements which derive from acrylonitrile, based on the sum total of polymers.

The biocidal substances of the invention may optionally comprise auxiliaries which influence the properties and the stability of the biocidal substances. Examples here include plasticizers and stabilizers, such as antioxidants, free-radical scavengers or UV-stabilizers. For controlling the release kinetics, it is also possible for inorganic extenders, such as natural finely ground minerals, such as kaolins, argillaceous earths, talc, calcium carbonate (marble), chalk, quartz, attapulgite, montmorillonite or diatomaceous earth and synthetic inorganic substances, such as highly disperse silica, aluminum oxide and silicates, to be present in the biocidal substance.

The biocidal substances in the invention comprise one or more polymers which comprise one or more biocides.

In one preferred embodiment the biocidal substances comprise 2% to 80% by weight, preferably 3% to 50% by weight, and more preferably 5% to 40% by weight of one or more biocides.

In another preferred embodiment, the polymers of the biocidal substances comprise 2% to 80% by weight, preferably 3% to 50% by weight, and more preferably 5% to 40% by weight of one or more biocides, and in an even more preferred embodiment the biocide or biocides is or are incorporated monolithically into the polymer or polymers.

Biocides may be, for example, fungicides, algicides, insecticides, acaricides, nematicides, radicides and herbicides or mixtures thereof, with fungicides and algicides or mixtures thereof being preferred. Especially preferred biocides are algicides.

The algicides are preferably selected from the group consisting of triazine algicides, urea algicides and uracil algicides. Triazine algicide are, for example, terbutryn, cybutryne, propazine or terbuton; urea algicides are, for example, diuron, benzthiazuron, methabenzthiazuron, tebuthiuron, and isoproturon; a uracil algicide is, for example, terbacil.

The algicides are more preferably selected from the group consisting of isoproturon, diuron, cybutryne, and terbutryn.

With very particular preference the polymer or polymers comprise isoproturon or diuron or cybutryne or terbutryn, or diuron and terbutryn, or diuron and isoproturon, or terbutryn and isoproturon, or cybutryne and diuron, or cybutryne and terbutryn, or diuron and terbutryn and isoproturon.

If desired, in another embodiment, the biocidal substance may or may not, in addition to algicides, further comprise one or more other active biocidal ingredients such as more particularly fungicides. With very particular preference, the fungicides are azaconazole, bromuconazole, cyproconazole, diclobutrazol, diniconazole, hexaconazole, metaconazole, penconazole, propiconazole, tebuconazole, dichlofluanid, tolylfluanid, fluorfolpet, methfuroxam, carboxin, fenpiclonil, butenafine, imazalil, N-octylisothiazolin-3-one, dichloro-N-octylisothiazolinone, mercaptobenzothiazole, thiocyanatomethylthiobenzothiazole, thiabendazole, N-butylbenzisothiazolinone, 1-hydroxy-2-pyridinethione (and the Cu, Na, Fe, Mn, and Zn salts thereof), tetrachloro-4-methylsulfonylpyridine, 3-iodo-2-propynyl n-butylcarbamate, bethoxazin, 2,4,5,6-tetrachloroisophthalodinitrile, and carbendazim.

Insecticides, acaricides and nematicides are, for example selected from the following group:

abamectin, acephate, acetamiprid, acetoprole, acrinathrin, alanycarb, aldicarb, aldoxycarb, aldrin, allethrin, alpha-cypermethrin, amidoflumet, amitraz, avermectin, azadirachtin, azinphos A, azinphos M, azocyclotin,
barthrin, 4-bromo-2-(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, bioresmethrin, bioallethrin, bistrilfluoron, bromophos A, bromophos M, bufencarb, buprofezin, butathiophos, butocarboxim, butoxycarboxim,
cadusafos, carbaryl, carbofuran, carbophenothion, carbosulfan, cartap, quinomethionate, cloethocarb, chlordane, chlorethoxyfos, chlorfenapyr, chlorfenvinphos, chlorfluazuron, chlormephos, N-[(6-chloro-3-pyridinyl)methyl]-N′-cyano-N-methylethaneimidamide, chloropicrin, chlorpyrifos A, chlorpyrifos M, cis-resmethrin, clocythrin, clothiazoben, cypophenothrin, clofentezine, coumaphos, cyanophos, cycloprothrin, cyfluthrin, cyhalothrin, cyhexatin, cypermethrin, cyromazine,
decamethrin, deltamethrin, demeton M, demeton S, demeton-5-methyl, diafenthiuron, dialiphos, diazinon, 1,2-dibenzoyl-1(1,1-dimethyl)hydrazine, DNOC, dichlofenthion, dichlorvos, dicliphos, dicrotophos, difethialone, diflubenzuron, dimethoate, 3,5-dimethylphenyl methylcarbamate, dimethyl(phenyl)silylmethyl-3-phenoxybenzyl ether, dimethyl(4-ethoxyphenyl)silylmethyl 3-phenoxybenzyl ether, dimethylvinphos, dioxathion, disulfoton,
eflusilanate, emamectin, empenthrin, endosulfan, EPN, esfenvalerate, ethiofencarb, ethion, ethofenprox, etrimphos, etoxazole, etobenzanid,
fenamiphos, fenazaquin, fenbutatin oxide, fenfluthrin, fenitrothion, fenobucarb, fenothiocarb, fenoxycarb, fenpropathrin, fenpyrad, fenpyroximate, fensulfothion, fenthion, fenvalerate, fipronil, flonicamid, fluacrypyrim, fluazuron, flucycloxuron, flucythrinate, flufenerim, flufenoxuron, flupyrazofos, flufenzine, flumethrin, flufenprox, fluvalinate, fonophos, formethanate, formothion, fosmethilan, fosthiazate, fubfenprox, furathiocarb,
halofenozide, HCH, (CAS RN: 58-89-9), heptenophos, hexaflumuron, hexythiazox, hydramethylnon, hydroprene,
imidacloprid, imiprothrin, indoxycarb, iprinomectin, iprobenfos, isazophos, isoamidophos, isofenphos, isoprocarb, isoprothiolane, isoxathion, ivermectin,
kadedrin,
lambda-cyhalothrin, lufenuron,
malathion, mecarbam, mervinphos, mesulfenphos, metaldehyde, methacrifos, methamidophos, methidathion, methiocarb, methomyl, metolcarb, milbemectin, monocrotophos, moxiectin,
naled, NI 125, nicotine, nitenpyrarn, noviflumuron,
omethoate, oxamyl, oxydemethon M, oxydeprofos,
parathion A, parathion M, penfluoron, permethrin, 2-(4-phenoxyphenoxy)ethyl ethylcarbamate, phenthoate, phorate, phosalon, phosmet, phosphamidon, phoxim, pirimicarb, pirimiphos M, pirimiphos A, prallethrin, profenophos, promecarb, propaphos, propoxur, prothiophos, prothoate, pymetrozin, pyrachlophos, pyridaphenthion, pyresmethrin, pyrethrum, pyridaben, pyridalyl, pyrimidifen, pyriproxifen, pyrithiobac-sodium,
quinalphos,
resmethrin, rotenone,
salithion, sebufos, silafluofen, spinosad, spirodiclofen, spiromesifen, sulfotep, sulprofos,
tau-fluvalinate, taroils, tebufenozide, tebufenpyrad, tebupirimphos, teflubenzuron, tefluthrin, temephos, terbam, terbufos, tetrachlorvinphos, tetramethrin, tetramethacarb, thiacloprid, thiafenox, thiamethoxam, thiapronil, thiodicarb, thiofanox, thiazophos, thiocyclam, thiomethon, thionazin, thuringiensin, tralomethrin, transfluthrin, triarathen, triazophos, triazamate, triazuron, trichlorfon, triflumuron, trimethacarb,
vamidothion, xylylcarb, zetamethrin;
molluscicides:
fentin acetate, metaldehyde, methiocarb, niclosamide;
herbicides are for example selected from the following group:
acetochlor, acifluorfen, aclonifen, acrolein, alachlor, alloxydim, ametryn, amidosulfuron, amitrole, ammonium sulfamate, anilofos, asulam, atrazine, azafenidin, aziptrotryne, azimsulfuron,
benazolin, benfluralin, benfuresate, bensulfuron, bensulfide, bentazone, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,
carbetamide, carfentrazone-ethyl, carfenstrole, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinosulfuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulfamuron,
diclosulam, dichlorprop, dichlorprop-P, diclofop, diethatyl, difenoxuron, difenzoquat, diflu-fenican, diflufenzopyr, dimefuron, dimepiperate, dimethachlor, dimethipin, dinitramine, dinoseb, dinoseb acetate, dinoterb, diphenamid, dipropetryn, diquat, dithiopyr, DNOC, DSMA, 2,4-D, daimuron, dalapon, dazomet, 2,4-DB, desmedipham, desmetryn, dicamba, dichlobenil, dimethamid, dithiopyr, dimethametryn, eglinazine, endothal, EPTC, esprocarb, ethalfluralin, ethidimuron, ethofumesate, ethobenzanid, ethoxyfen, ethametsulfuron, ethoxysulfuron,
fenoxaprop, fenoxaprop-P, fenuron, flamprop, flamprop-M, flazasulfuron, fluazifop, fluazifop-P, fuenachlor, fluchloralin, flufenacet, flumeturon, fluorocglycofen, fluoronitrofen, flupropanate, flurenol, fluridone, fluorochloridone, fluoroxypyr, fomesafen, fosamine, fosametine, flamprop-isopropyl, flamprop-isopropyl-L, flufenpyr, flumiclorac-pentyl, flumipropyn, flumioxzim, flurtamone, flumioxzim, flupyrsulfuron-methyl, fluthiacet-methyl,
glyphosate, glufosinate-ammonium,
haloxyfop, hexazinone,
imazamethabenz, isoxaben, isoxapyrifop, imazapyr, imazaquin, imazethapyr, ioxynil, isopropalin, imazosulfuron, imazomox, isoxaflutole, imazapic,
ketospiradox,
lactofen, lenacil, linuron,
MCPA, MCPA-hydrazide, MCPA-thioethyl, MCPB, mecoprop, mecoprop-P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, manolide, monolinuron, MSMA, metolachlor, metosulam, metobenzuron,
naproanilide, napropamide, naptalam, neburon, nicosulfuron, norflurazon, sodium chlorate,
oxadiazon, oxyfluorfen, oxysulfuron, orbencarb, oryzalin, oxadiargyl,
propyzamide, prosulfocarb, pyrazolate, pyrazosulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propham, propisochlor, pyriminobac-methyl, pelargonic acid, pyrithiobac, pyraflufen-ethyl,
quinmerac, quinocloamine, quizalofop, quizalofop-P, quinchlorac,
rimsulfuron,
sethoxydim, sifuron, simazine, simetryn, sulfosulfuron, sulfometuron, sulfentrazone, sulcotrione, sulfosate,
tar oils, TCA, TCA-sodium, tebutam, terbacil, terbumeton, terbuthylazine, thiazafluoron, thifensulfuron, thiobencarb, thiocarbazil, tralkoxydim, triallate, triasulfuron, tribenuron, triclopyr, tridiphane, trietazine, trifluoralin, tycor, thdiazimin, thiazopyr, triflusulfuron,
vernolate.

Radicides are, for example, selected from the group of the auxins and encompass more particularly the following:

2,4-dichlorophenoxyacetic acid, 2,4-dichlorophenoxybutyric acid, alpha-naphthaleneacetic acid, 4-amino-3,5,6-trichloropicolinic acid, alpha-(p-phenoxy)isobutyric acid, 2-(4-chloro-2-methylphenoxy)propionic acid, and also the esters and amides of the aforesaid acids, such as, more particularly the n-octyl, 2-ethylhexyl, and polyglycol esters of 2-(4-chloro-2-methylphenoxy)propionic acid.

In one embodiment the amount of one or more polymers which in turn comprise one or more biocides in the biocidal substance, at least one polymer having structural elements which derive from acrylonitrile, is more than 90% by weight, preferably more than 95% by weight. Merely for clarification, it is noted that the figure relates to the polymer or polymers inclusive of the amount of active biocidal ingredients therein.

The biocidal substances of the invention may be obtained, for example, by polymerization of the monomers on which the polymers are based, in the presence of the biocides and optionally in the presence of auxiliaries. This mode of preparation is also referred to below as “co-polymerization”.

The biocidal substances are preferably prepared in a process which comprises
a) mixing at least one or more polymers, of which at least one polymer has structural elements which derive from acrylonitrile and one or more biocides and/or auxiliaries, and
b) extruding the mixture obtained according to a) at a temperature from 50 to 220° C.

For the mixing in step a), the polymer or polymers are used preferably in pelletized, flaked or powdered form.

The extruding in step b) is accomplished preferably at a temperature of 50 to 220° C., and carrying out substantial homogenization by introduction of mechanical energy.

From a technical standpoint, this is done using extruders which are commonly designed as screw extruders, but may also be ram extruders. These screw extruders may be equipped with either only one screw or else with a twin screw. They are fed with the mixture obtained according to step a), for example, through a feed hopper or other feed device. While the screw transports the mixture of solids through the extruder, this mixture is first of all heated and then substantially homogenized and plastified in the screw at the desired temperature. The extrudate is subsequently pressed from the extruder through a die, for example, as a strand. Not only single screw but also multi screw extruders can be used for this extrusion.

The different temperatures occurring in the extruder may vary within a wide temperature range and in different zones.

The contact times in the extruder, in the heated section of the extruder, may vary within a very wide range. In general the contact times are 5 seconds to 5 minutes, preferably 10 seconds to 2 minutes.

Depending on requirements or on the desired degree of homogenization, a plurality of extruder passes are run.

To the skilled person it is clear that, depending on the composition and properties of the polymers and of the biocide and auxiliaries, either co-polymerization or extrusion is more suitable. This can be determined by the skilled worker, if not already evident from the physical properties of the substances employed, in a simple way by means of preliminary tests. For the preferred biocidal substances, however, more particularly in the case of algicidal substances, extrusion is typically likewise preferred.

The biocidal substances of the invention are suitable more particularly for use in or as biocidal compositions. The invention therefore also encompasses biocidal compositions comprising at least one biocidal substance of the invention, and also the use of the biocidal substances of the invention as a biocidal composition or in biocidal compositions.

For use in the biocidal compositions of the invention, the biocidal substance comprising one or more biocides is preferably present in particulate form, the term “particulate” denoting the fact that more than 90%, more particularly more than 95%, of all the particles, on a weight-average basis, have a size of 150 μm or less, preferably of 1 to 150 μm, more preferably 1 to 100 μm.

Particulate biocidal substances can be prepared in a conventional manner by comminution, such as, for example, by milling, of the biocidal substances.

Milling may take place in the presence or else in the absence of non-solvent liquids. By non-solvent liquids are meant those in which the polymer or polymers of the biocidal substance are soluble to an extent of less than 1% by weight. Where non-solvent liquids are present, water is typically used as non-solvent liquid.

Comminution is accomplished, for example, by exposure to mechanical force such as collision, impact, pressure, friction or shearing, or combinations of aforesaid forces.

Where milling apparatus is used, exposure to mechanical force is accomplished typically by way of milling elements which are rotating, vibrating or tumbling or performing other movements. Examples of suitable milling apparatus include ball mills, cutter mills, hammer mills, and jet mills, such as fine impact mills, opposed jet mills, crossflow mills, or spiral jet mills. Examples of further milling apparatus includes roll mills, tubular mills, disk mills, toothed disk mills, vibratory mills, cone mills, spring roller mills, centrifugal roller mills or crosshammer mills.

In the case of polymers having a low glass transition temperature, comminution may also be carried out at reduced temperatures, in order to achieve sufficient brittleness on the part of the milled material. Carbon dioxide, ice or liquid nitrogen may be used here as coolants, or the mills are cooled to the appropriate temperature by means of corresponding cooling assemblies.

The particulate biocidal substances are preferably prepared in a process which in addition to steps a) and b) set out above, includes a step c), wherein the extrudate obtained after step b) is comminuted such that more than 90% by weight, more particularly more than 95% by weight, of all the particles, based on the extrudate used, have a size of 150 μm or less, preferably of 1 to 150 μm, more preferably 1 to 100 μm.

As a result of the mechanical comminution, the particulate biocidal substances typically possess an irregular shape, more particularly with grooves or furrows. The distribution of the active ingredient is typically substantially homogeneous as a result of the extrusion.

The biocidal substances or particulate biocidal substances of the invention preferably have a fraction of volatile organic compounds having a boiling point of 250° C. at 1013 hPa (VOC, volatile organic content) of less than 1% by weight, preferably of less than 0.1% by weight, more preferably of less than 0.01% by weight and very preferably of less than 0.001% by weight.

The particulate biocidal substances are preferably free from aziridines.

The biocidal compositions of the invention may be present in any desired formulation, such as, for example, in the form of suspension concentrates (SC), wettable powders (WP), water-dispersible granules (WG) or simple powder mixtures, with preference being given to suspension concentrates (SC), powder mixtures and water-dispersible granules (WG).

In principle, preferred types of formulation are substantially dependent on the intended use and on the physical properties required for that use. Since these factors are known, however, it is common practice for the skilled person to determine a preferred type of formulation in a few tests.

The formulations may additionally also comprise further substances, such as stabilizers, in-can preservatives, and other biocides not present in polymers, such as, for example fungicides, algicides, insecticides, acaricides, nematicides, radicides and herbicides or mixtures thereof, preferably fungicides or algicides or mixtures thereof, very preferably algicides.

In addition to the particulate biocidal substances, the biocidal compositions may optionally further comprise various auxiliaries. For the auxiliaries identified below, it is also possible in each case, independently of one another, that they are not included. Examples of possible auxiliaries are
interface-active substances, such as, for example, surfactants. Surfactants may be, for example, nonionic, cationic, and amphoteric surfactants, preferably anionic surfactants. Suitable anionic surfactants are, for example, alkyl sulfates, alkyl ether sulfates, alkylarylsulfonates, alkyl succinates, alkyl sulfosuccinates, N-alkoylsarcosinates, acyl taurates, acyl isethionates, alkyl phosphates, alkyl ether phosphates, alkyl ether carboxylates, alpha-olefinsulfonates, in particular the alkali and alkaline-earth metal salts, for example sodium, potassium, magnesium, calcium, and ammonium and triethanolamine salts. The alkyl ether sulfates, alkyl ether phosphates, and alkyl ether carboxylates can in each case have, for example, between 1 to 10 ethylene oxide or propylene oxide units, preferably 1 to 3 ethylene oxide units. Examples of substances which are suitable are sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate. In this context, the biocidal compositions of the invention may comprise, for example, from 0.01% to 10%, preferably from 0.2% to 8%, more preferably from 0.3% to 5% and very preferably 0.5% to 3% by weight of interface-active substances.
Defoamers. Defoamers used are generally interface-active substances whose solubility in the surfactant solution is weak. Preferred defoamers are those which derive from natural fats and oils, petroleum derivatives or silicone oils.
Wetting agents, such as, for example, alkali metal, alkaline earth metal, ammonium salts of aromatic sulfonic acids, e.g. lignosulfonic acid, phenolsulfonic acid, naphthalenesulfonic acid and dibutylnaphthalenesulfonic acid, and of fatty acids, of alkyl- and alkylarylsulfonates, of alkyl sulfates, lauryl ether sulfates and fatty alcohol sulfates, and the salts of sulfated hexa-, hepta- and octadecanols or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ethers, ethoxylated isooctyl-, octyl- or nonylphenol, alkylphenol or tributylphenyl polyglycol ether, trissterylphenyl ether ethoxylates, alkylaryl polyether alcohols, isotridecyl alcohol, fatty alcohol/ethylene oxide condensates, ethoxylated castor oil, polyoxyethylene alkyl ethers or polyoxypropylene, lauryl alcohol polyglycol ether acetate, sorbitol esters, lignin-sulfite waste liquors or methylcellulose. In this context, the biocidal compositions according to the invention may comprise, for example, 0.01% to 8%, preferably 0.2% to 6%, more preferably 0.3% to 5% and very 0.5% to 3% by weight of wetting agents.
Emulsifiers, such as, for example, sodium salts, potassium salts, and ammonium salts of straight-chain aliphatic carboxylic acids of chain length C₁₂-C₂₀, sodium hydroxyoctadecanesulfonate, sodium salts, potassium salts and ammonium salts of hydroxy-fatty acids of chain length C₁₂-C₂₀ and their sulfation or acetylation products, alkyl sulfates, also as triethanolamine salts, alkyl-(C₁₀-C₂₀)-sulfonates, alkyl(C₁₀-C₂₀-arylsulfonates, dimethyldialkyl(C₈-C₁₈)-ammonium chloride, acyl-, alkyl-, oleyl- and alkylaryloxyethylates and their sulfation products, alkali-metal salts of the sulfosuccinic esters with aliphatic saturated monohydric alcohols of chain length C₄-C₁₆, sulfosuccinic acid 4-esters with polyethylene glycol ethers of monohydric aliphatic alcohols of chain length C₁₀-C₁₂ (disodium salt), sulfosuccinic acid 4-esters with polyethylene glycol nonylphenyl ether (disodium salt), sulfosuccinic acid bis-cyclohexyl ester (sodium salt), lignosulfonic acid and its calcium, magnesium, sodium and ammonium salts, polyoxyethylene sorbitan monooleate having 20 ethylene oxide groups, resin acids, hydrogenated and dehydrogenated resin acids and their alkali metal salts, dodecylated sodium diphenyl ether disulfonate, and copolymers of ethylene oxide and propylene oxide with a minimum content of 10% by weight of ethylene oxide. The following are preferably used as emulsifiers: sodium lauryl sulfate, sodium lauryl ether sulfate, ethoxylated (3 ethylene oxide groups); the polyethylene glycol-(4-20) ethers of oleyl alcohol, and the polyethylene oxide-(4-14) ethers of nonylphenol. In this context, the biocidal compositions of the invention may comprise, for example, 0.01% to 15%, preferably 0.2% to 8%, more preferably 0.5% to 6% and very preferably 1% to 5% by
Dispersants, such as, for example, alkylphenol polyglycol ethers. In this context, the biocidal compositions of the invention may comprise, for example, 0.01% to 8%, preferably 0.1% to 6%, especially preferably 0.2% to 5% and very preferably 0.4% to 3% by weight of dispersants.
Stabilizers, such as, for example, cellulose and cellulose derivatives. In this context, the biocidal compositions of the invention may comprise, for example, 0.01% to 6%, preferably 0.01% to 3%, more preferably 0.01% to 2% and very preferably 0.01% to 1% by weight of stabilizers.
Stickers, such as carboxymethylcellulose, natural and synthetic polymers in the form of powders, granules or lattices, such as gum arabic, polyvinyl alcohol, polyvinyl acetate, and natural phospholipids, such as cephalins and lecithins, and synthetic phospholipids, and liquid paraffins. In this context, the biocidal compositions of the invention may comprise, for example, 0.01% to 8%, preferably 0.1% to 4%, more preferably 0.2% to 3% and very preferably 0.2% to 2% by weight of stickers.
Spreaders, such as, for example, isopropyl myristate, polyoxyethylene nonylphenyl ether and polyoxyethylene laurylphenyl ether. In this context, the biocidal compositions of the invention may comprise, for example, 0.01% to 20%, preferably 0.1% to 10%, more preferably 0.1% to 5% and very preferably 0.1% to 2% by weight of spreaders.
Fragrances and colorants, such as inorganic pigments, for example, iron oxide, titanium oxide, Prussian blue, and organic dyes, such as alizarin, azo and metal phthalocyanine dyes, and trace nutrients such as salts of iron, manganese, boron, copper, cobalt, molybdenum, and zinc. In this context, the biocidal compositions of the invention may comprise, for example, in each case 0.001% to 4%, preferably 0.01% to 1%, more preferably 0.01% to 0.8% by weight of fragrances and colorants.
Buffer substances, buffer systems or pH regulators. In this context, the biocidal compositions of the invention may comprise, for example, in each case 0.01% to 10%, preferably 0.1% to 5% by weight of buffer substances, buffer systems or pH regulators.
Thickeners, such as for example, polysaccharides, xanthan gum, sodium or magnesium silicates, heteropolysaccharides, alginates, carboxymethylcellulose, gum arabic or polyacrylic acids, preferably xanthan gum.
Stabilizers such as, for example, antioxidants, free-radical scavengers or UV absorbers.

The total amount of the above-stated auxiliaries in the biocidal compositions is generally, for example, from 0.001% to 20% by weight, preferably from 0.1% to 15% by weight and more preferably from 0.1% to 10% by weight.

Solid formulations, such as powder mixtures of water-dispersible granules (WG), for example, may comprise not only the particulate biocidal substances but also solid auxiliaries such as, for example, natural finely ground minerals, such as kaolins, argillaceous earths, talc, marble, chalk, quartz, attapulgite, montmorillonite or diatomaceous earth, or synthetic inorganic substances, such as highly disperse silica, aluminum oxide and silicates, or mixtures thereof.

The solid formulations may additionally further comprise auxiliaries as well, such as interface-active substances, wetting agents, emulsifiers, dispersants, de-dusting agents or flow assistants or release agents. For the interface-active substances, wetting agents, emulsifiers or dispersants, it is possible to use the substances which can be used for preparing the liquid formulations such as suspension concentrates, dispersions, gels or pastes.

De-dusting agents are, for example, polyglycols and polyglycol ethers. In this context, the biocidal compositions of the invention may comprise, for example, in each case, 0.01% to 2%, preferably 0.05% to 1%, more preferably 0.1% to 0.5% by weight of de-dusting agents.

As flow agents or release agents it is possible to make use, for example, of highly disperse silica or of Mg salts of fatty acids. In this context, for improving the fluidity of the solids, the biocidal compositions of the invention may comprise in each case 0.01% to 5%, preferably 0.05% to 3%, more preferably 0.1% to 2% by weight of flow agents.

The solid formulations may be obtained in a conventional manner, as for example by intimate mixing of the particulate biocidal substances with the solid auxiliaries or by jointly comminuting solid auxiliaries with the biocidal substances. In addition, the solid formulations may be obtained by drying, such as spray-drying, for example, of a liquid formulation.

Preferred solid formulations comprise, for example, 10 to 100% by weight of the particulate biocidal substances of the invention, preferably 15 to 98% by weight.

Liquid formulations may be, for example, suspension concentrates (SC), dispersions, gels or pastes.

Preferred liquid formulations are preferably aqueous dispersions.

The liquid formulations such as, more particularly the dispersions, may be prepared in a conventional manner, for example, by jointly comminuting the biocidal substances and other substances which are to be present in the liquid formulation, or by intimately mixing the particulate biocidal substances and the other substances which are to be present in the liquid formulation with one another by means of a dissolver or stirrer.

The liquid formulations comprise generally 2% to 95% by weight, preferably 5% to 75% by weight of the particulate biocidal substances of the invention.

The biocidal substances, particulate biocidal substances and biocidal compositions of the invention have a good activity, like the biocides they comprise. More particularly, the biocidal substances, particulate biocidal substances, and biocidal compositions of the invention, where they comprise algicides, have activity more particularly against algae and, where they comprise fungicides, have activity more particularly against fungi, or, where they comprise algicides and fungicides, have activity more particularly against algae and fungi. In comparison to other biocidal polymers, furthermore, they possess a significantly reduced leaching rate.

The invention therefore also encompasses particulate biocidal substances which possess a D⁹⁰ value of 150 μm, preferably 10 to 100 μm, and in the 72 h irrigation test exhibit a leaching rate, with respect to the biocide present in the biocidal substance, of less than 30%, preferably less than 20%.

Where two or more biocides are present in the particulate biocidal substance, the 72 h irrigation test is carried out for each biocide included in the particulate biocidal substance.

In this case, the invention also encompasses particulate biocidal substances which have a D90 value of 150 μm, preferably 10 to 100 μm, and in the 72 h irrigation test exhibit a leaching rate of at least one biocide, and preferably all the biocides present in the biocidal substance, of less than 30%, preferably less than 20%.

By the D90 here is meant the particle size at which 90% by weight of all the particles of the particulate biocidal substance are smaller than the stated D90 value.

The 72 h irrigation test is carried out by introducing an amount of particulate biocidal substance into an amount of preferably 500 to 1000 ml of deionized water, the amount of biocidal substance being such that the amount of biocide introduced in this form corresponds to the solubility of the free biocide at 20° C. in the selected amount of water, stirring the resultant suspension at 20° C. for 72 hours, and then subjecting the fraction dissolved in the water phase to analytical determination, preferably by means of HPLC.

For the skilled person it is clear that the leaching rate is dependent both on the particle size and on the selected polymer of the biocidal polymer. Particle sizes and leaching rate are indicated, accordingly, above.

When investigating two or more biocides with different solubilities in water, it is necessary to carry out individual tests in each case for the individual biocides.

Accordingly, the invention also encompasses a method for controlling microorganisms which comprises using, for the controlling, the biocidal compositions of the invention or the particulate biocidal substances of the invention.

Where the particulate biocidal polymers and biocidal compositions of the invention comprise algicides, algae can be controlled to good effect.

Algae are preferably prokaryotic algae (Cyanophyta, blue algae) such as, for example representatives of the subclass Coccogoneae and of the subclass Hormogoneae.

By way of example, mention may be made, from the order Chroococcales, of species of the genera Synechococcus, Chroococcus, Gloeocapsa, Aphanocapsa, Aphanothece, Microcystis, and Merismopedia; from the orders Chamaesiphonales and Pleurocapsales, of species of the genera Chamaesiphon and Dermatocarpa; from the order Oscillatoriales, of species of the genera Phormidium, Schizothrix, Spirulina, Plectonema, and Lyngbya; from the order Nostocales, of species of the genera Nostoc, Rivularia, Tolypothrix, Scytonema, Anabaenopsis, Calothrix, and Aulosira; from the order Stigonematatles, of species of the genera Stigonema, Fischerella, Hapalosiphon, and Mastigocladus.

Furthermore, the compounds also display good activity against eukaryotic representatives from the divisions Heterokontophyta, Rhodophyta, Chlorophyta, Euglenophyta, Cryptophyta, Dinophyta and Haptophyta.

By way of example, mention may be made, from the class Xanthophyceae, of species of the genera Tribonema and Vaucheria; from the class Chrysophyceae, of species of the genera Chrysocapsa, Rhizochrysis, Cfbrysosphaera, Phaeothamnion, and Thallochrysis; from the class Phaeophyceae (brown algae), of species of the genera Ectocarpus, Pylaiella, Cutleria, Zanardinia, Dictyota, Padina, Dictyopteris, Laminaria, Macrocystis, Lessonia, Nerocystis, Chorda, Alaria, Fucus, Ascophyllum, Himanthalia, Sargassum, Cystoseira, Halidrys, Pelvetia, Coccophora, and Durvilla; from the class Rhodophyceae (red algae), of species of the genera Porphyridum, Bangia, Porphyra, Corallina, Lithothamnia, Lithophyllum, Rhodymania, Delesseria, Grinnellia, Platysiphonia, Polysiphonia, Ceramium, and Plumaria; and from the class Chlorophyceae (green algae), of species of the genera Chlorococcum, Chlorella, Spongiochloris, Monostroma, Ulva, Enteromorpha, Ulothrix, Trentepohlia, Apatococcus, Desmococcus, Cladophora, Siphonocladus, Valonia, Caulerpa, Bryopsis, Acetabularia, Halimeda, and Tuna.

Where the particulate biocidal substances and biocidal compositions of the invention comprise fungicides, fungi can be controlled to good effect.

Examples of fungi include microorganisms from the following genera:

Alternaria, such as, for example, Alternaria tenuis, Aspergillus, such as, for example, Aspergillus niger, Chaetomium, such as, for example, Chaetomium globosum, Coniophora, such as, for example, Coniophora puetana, Lentinus, such as, for example Lentinus tigrinus, Penicillium, such as, for example, Penicillium glaucum, Polyporus, such as, for example, Polyporusl versicolor, Aureobasidium, such as, for example, Aureobasidium pullulans, Sclerophoma, such as, for example, Sclerophoma pityophila, and Trichoderma, such as, for example, Trichoderma viride.

The invention therefore also encompasses a method for controlling microorganisms which comprises using, for said controlling, the biocidal compositions of the invention, or the particulate biocidal substances of the invention.

The invention further provides for the use of the particulate biocidal substances or of the biocidal compositions of the invention for protecting technical materials, and also provides technical materials comprising the biocidal compositions or particulate biocidal substances of the invention.

The invention additionally provides for the use of polymers having structural elements which derive from acrylonitrile for preparing biocidal substances comprising these polymers and also at least one biocide.

Technical materials are, for example, building materials, wood, woodbased materials, wood-plastic composites, sealants, joint seals, plastics, films, stone slabs, textiles such as, for example, tarpaulins and tents, textile composites, coating materials such as, for example, paints and varnishes, concrete, cement, mortar or coating agents such as renders, for example.

With particular preference, the biocidal substances, particulate biocidal substances or biocidal compositions, more particularly when they comprise algicides or fungicides or mixtures thereof, are used in emulsion paints or in coating materials such as renders, for example.

By emulsion paints are meant aqueous coating materials which are typically alkaline in formulation and are based on polymer dispersions. The polymer dispersions used for preparing emulsion paints comprise, by way of example and preference, polyacrylates, styrene acrylates, polyvinyl acetate, polyvinyl propionate, and other polymers.

Renders may be composed of a wide variety of materials, but in principle, typically, of a binder, adjuvants and water. The various renders are usually distinguished according to their materials. Since the influence of the binders is the greatest influence on the properties of the render, the binder serves as the most frequently used criterion for distinction.

According to the binder, a distinction is made between mineral renders and synthetic-resin renders. Mineral renders have inorganic binders, especially lime and cement, but also gypsum, especially for interiors, or loam as a conventional version. Synthetic-resin renders have organic binders.

The application concentrations of the biocidal substances, particulate biocidal substances or biocidal compositions of the invention are guided by the nature and incidence of the microorganisms to be controlled, and also by the composition of the material which is to be protected. The optimum amount for use can be determined by means of test series, in a simple way which is adequately known to the skilled person.

The technical materials such as, more particularly the completed emulsion paints or renders generally comprise an amount of the biocidal substances, particulate biocidal substances or biocidal compositions of the invention which is such as to produce a biocide content of 0.0001 to 0.5% by weight, preferably of from 0.0005% to 0.3% by weight.

The advantage of the invention is to be seen in that the biocidal polymers of the invention exhibit a superior—that is, reduced—leaching behavior.

### EXAMPLES

### Example 1a (Inventive)

2.00 kg/h of a styrene-acrylonitrile (SAN, Lustran® SAN M60 from Ineos; 28% acrylonitrile content) and 0.857 kg/h of diuron were metered continuously into the intake hopper of a twin-screw extruder of type ZSK 34 (in-house design, Bayer Technology Services GmbH) and jointly melted. The speed of the extruder was 110 rpm, the heating temperature was 200° C., and the emerging extrudate had a temperature of 194° C. The extrudate was cooled with an air lance and then pelletized.

The pelletized biocidal (algicidal) polymer thus obtained gave an average glass transition temperature of 58° C. under DSC measurement. The active ingredient content of the pelletized extrudate was 25.5% by weight (measured by HPLC)

### Example 1b (Comparative)

2.00 kg/h of a polystyrene (PS, Polystyrene 145D from BASF SE) and 0.857 kg/h of diuron were metered continuously into the intake hopper of a twin-screw extruder of type ZSK 34 (in-house design, Bayer Technology Services GmbH) and jointly melted. The speed of the extruder was 110 rpm, the heating temperature was 200° C., and the emerging extrudate had a temperature of 194° C. The extrudate was cooled with an air lance and then pelletized.

The pelletized biocidal (algicidal) polymer thus obtained gave an average glass transition temperature of 60.5° C. under DSC measurement. The active ingredient content of the pelletized extrudate was 25.5% by weight (measured by HPLC)

### Examples 2a (Inventive) and 2b (Comparative)

The pelletized biocidal (algicidal) polymers obtained in examples 1a (example 2a) and 1b (example 2b) were first comminuted in a Bauermeister UTL fan mill and then finely ground on an Alpine 50 ZPS classifier mill with a mill rotor peripheral speed of 105 m/s and a classifying wheel peripheral speed of 26 m/s at a temperature of 25 to 30° C.

Following measurement in water with Tween 80 and ultrasound, the resultant particulate biocidal (algicidal) polymers exhibited the following particle sizes under laser scattering [Coulter®LS/Coulter-Beckmann]:

### Example 2a: D₉₀=45.6 μm, D₅₀=25.3 μm, D₁₀=10.2 μm

### Example 2b: D₉₀=48.3 μm, D₅₀=27.5 μm, D₁₀=13.1 μm

The D90 value is the particle size at which 90% of the particles are smaller by mass. D50 is the value related to 50% and D10 the value related to 10% of the particles (by mass).

### Examples 3a (Inventive) and 3b (Comparative)

The particulate biocidal (algicidal) polymers obtained in examples 2a (example 3a) and 2b (example 3b) were each formulated as a suspension.

For this purpose, the particulate biocidal (algicidal) polymer from example 2 was suspended in water/Soprophor S25 and then stirred magnetically for about half an hour with antifoam, Rhodopol® G solution, Preventol® BIT 20 D and Preventol® D7.

### Formula:

| | |
|---|---|
| Particulate biocidal (algicidal) polymer from example 2a or 2b: | 20.00 g |
| 2% strength Soprophor S25 solution (an emulsifier based on | 25.10 g |
| tristyrylphenyl ether ethoxylates): | |
| 1% strength Rhodopol G solution (thickener based on xanthan | 5.03 g |
| gum): | |
| Wacker antifoam SRE: | 0.360 g |
| Preventol ® BIT 20 D [in-can preservative with about 20% | 0.062 g |
| by weight of benzisothiazolinone] | |
| Preventol ® D7 [in-can preservative with about 1.5% by weight | 0.053 g |
| of chloromethylisothiazolinone/methylisothiazolinone 3:1] | |
| Total | 50.61 g |

An amount of 8.36% by weight of diuron was found by HPLC in the formulation of each of the biocidal compositions.

### Examples 4a (Inventive) and 4b (Comparative)

For determination of the release of the active ingredient in water, the formulations from example 3a (example 4a) and 3b (example 4b) were each stirred in 1000.0 g of deionized water, at a total diuron content of 35 ppm, for 72 hours, and the dissolved fraction was determined analytically. The maximum solubility of diuron in water under these conditions is 35 ppm, i.e., 0.0035% by weight; smaller amounts of diuron detectable freely in the solution indicate retention or retarded release of the active ingredient.

In a glass beaker, 853.2 g of DI water 35 ppm of diuron) were added to 328.5 mg of each of the formulations from examples 3a and 3b, and this system was stirred at a uniform rate (stirrer speed 100 rpm) with magnetic stirring at room temperature, slowly for 72 hours, using a magnetic stirrer. After this time, approximately 200 ml of the mixture were filtered through a fluted filter (S&S 595) and then centrifuged at 3000 rpm for 5 minutes. The supernatant was drawn off with a pipette and the diuron content was determined by means of quantitative DC.

For example 4a), 2.5 ppm of diuron were found in the water phase, corresponding to a release rate of diuron from the algicidal polymer of only 7.1%.

For example 4b), 13.0 ppm of diuron were found in the water phase, corresponding to a release rate of diuron from the algicidal polymer of 37.1%.

### Example 5

The particulate algicidal polymer obtained from example 2a was formulated as a suspension in the same way as example 3.

### Formula

| | |
|---|---|
| Particulate algicidal polymer from example 2a or 2 b: | 20.00 g |
| 2% strength Soprophor S25 solution | 19.00 g |
| 1% strength aqueous Rhodopol G solution | 7.00 g |
| Wacker antifoam SRE (silicone-based defoamer) | 0.383 g |
| Preventol ® BIT 20 D | 0.067 g |
| Preventol ® D7 | 0.073 g |
| Total | 46.52 g |

An amount of 9.98% by weight of diuron was found in the formulation by means of HPLC.

### Example 6

For the testing of emulsion paints for algae resistance, the following procedure was performed:

### Paint 1

2.5 g of the formulation from example 5 were incorporated into 100 g of an emulsion paint based on a straight acrylate. The diuron content was 2500 ppm.

### Paint 2

A paint containing 1100 ppm of diuron was obtained by mixing 22 g of paint 1 with 28 g of a paint with no preservative.

### Paint 3

A paint containing 550 ppm of diuron was obtained by mixing 5 g of paint 1 with 39 g of a paint with no preservative.

### Example 7 (Comparative)

### Paint 4

0.66 g of Preventol A 6-D (50% by weight aqueous suspension of diuron) was incorporated into 300 g of an emulsion paint based on a straight acrylate. The paint then had a diuron content of 1100 ppm.

### Paint 5

A paint containing 550 ppm of diuron was obtained by mixing 50 g of paint 4 with 50 g of a paint with no preservative.

### Example 8

The test paints 1 to 5 were each applied to both sides of water-resistant card (2 coats on the top side, 1 coat on the bottom side) and dried. The dried test specimens were then leached with running water at 20° C. for 72 hours and dried again.

The samples thus prepared were subsequently placed on an agar plate, and both the samples and the plate were inoculated with an algal suspension. Inspection was carried out after an incubation of 4 weeks at 20° C. under illumination at 3000 to 3500 lux.

The results are set out in table 1:

TABLE 1
(biological results from example 8, based on the paints from examples 6 and 7)

| | Diuron | | |
|---|---|---|---|
| | content | Test organisms in the | |
| Paint No. | of the paint | algal suspension | Result/appearance |
| 3 | 550 ppm | Stichococcus bacillaris | Agar covered by growth, coating |
| | | Scenedesmus vacuolatus | surface free from algae |
| 5 | 550 ppm | Stichococcus bacillaris | Agar and coating surface covered |
| (comparative) | | Scenedesmus vacuolatus | with growth of algae |
| 2 | 1100 ppm | Phormidium spec. | Agar slightly overgrown with |
| | | Phormidium tergestinum | algae, coating surface free from |
| | | Chlorella vulgaris | algae |
| | | Desmodesmus communis | |
| 4 | 1100 ppm | Phormidium spec. | Agar covered with growth, |
| (comparative) | | Phormidium tergestinum | coating surface covered with |
| | | Chlorella vulgaris | slight to moderate growth. |
| | | Desmodesmus communis | |

The straight-acrylate-based paint used in examples 5 to 8 corresponds to standard commercial paints, its composition being as follows:

Exterior emulsion paint based on Mowilith 771 (straight acrylate)

| Trade name | Parts by weight |
|---|---|
| Walsroder MC 3000 S 2% | 30 |
| Calgon N 10% | 3 |
| Additol XW 330 10% | 1 |
| Agitan in Texanol 1:1 | 1 |
| Titanium dioxide | 40 |
| Talco 1N | 15 |
| Durcal 5 | 45 |
| Water, distilled | 9.5 |
| White spirit | 5 |
| Butyldiglycol acetate | 1.5 |
| NaOH | 3.37 |
| Mowilith DM 771 | 85 |
| Preventol ® BIT TD from Lanxess Deutschland GmbH | 0.474 |
| (contains about 5% by weight of benzisothiazolinone | |
| and about 22% by weight of | |
| tetramethylolacetylenediurea) | |
| Total | 239.844 |

The paint has a pH of 8

What is claimed is:

1. Technical materials comprising biocidal compositions comprising one or more polymers comprising one or more biocides, at least one polymer having structural elements which derive from acrylonitrile.

2. The technical materials according to claim 1, wherein the at least one polymer having structural elements which derive from acrylonitrile comprises styrene acrylonitrile copolymers.

3. The technical materials according to claim 1 or 2, wherein the at least one polymer having structural elements which derive from acrylonitrile has a glass transition temperature of 50° C. to 220° C.

4. The technical materials according to any one of claims 1 to 3, wherein the at least one polymer having structural elements which derive from acrylonitrile possesses a molar mass of more than 1000 g/mol, preferably from 2000 to 200 000 and particularly preferably from 3000 to 170 000.

5. The technical materials according to any one of claims 1 to 4, wherein the biocidal substance comprises to an extent of at least 98% by weight those polymers which have structural elements which derive from acrylonitrile, based on the sum total of polymers.

6. The technical materials according to any one of claims 1 to 5, wherein the biocidal substances comprise 2% to 80% by weight of one or more biocides.

7. The technical materials according to any one of claims 1 to 6, wherein the one or more biocides are incorporated monolithically into the polymer or polymers of the biocidal substances.

8. The technical materials according to any one of claims 1 to 7, wherein the biocides are fungicides, algicides, insecticides, acaricides, nematicides, radicides and herbicides or mixtures thereof.

9. The technical materials according to any one of claims 1 to 8, wherein the biocides are fungicides or algicides or mixtures thereof.

10. The technical materials according to any one of claims 1 to 9, wherein the biocides are algicides and are selected from the group consisting of isoproturon, diuron, cybutryn and terbutryn.

11. The technical materials according to any of claims 1 to 10, wherein the biocidal compositions are present in particulate form.

12. A method for controlling microorganisms which comprises using, for said controlling, the biocidal compositions biocidal compositions comprising one or more polymers comprising one or more biocides, at least one polymer having structural elements which derive from acrylonitrile.
